(19) United States
(12) Patent Application Publication
(10) Pub. No.: US 2025/0078192 A1
(43) Pub. Date: Mar. 6, 2025

(54) ARTIFICIAL INTELLIGENCE SYSTEM PROVIDING AUTOMATED LEGAL SERVICES

(71) Applicant: BitHuman Inc

(72) Inventors: Steve Gu, Lafayette, CA (US); Yun Fu, Newton, MA (US)

(21) Appl. No.: 18/239,374

(22) Filed: Aug. 29, 2023

(51) Int. Cl. G06Q 50/18; G06F 21/32

(52) U.S. Cl. CPC G06Q 50/18; G06F 21/32

(57) ABSTRACT

Embodiments of the present disclosure may include an automated system for executing a legal event, the system may include an enrollment system, including a liveness test engine driven by artificial intelligence.

### BACKGROUND OF THE INVENTION

Embodiments of an artificial intelligence system for providing automated legal services and is able to execute legal events, including a liveness test engine driven by artificial intelligence.

### BRIEF SUMMARY

Embodiments of the present disclosure may include an automated system for executing a legal event, the system may include an enrollment system, including a liveness test engine driven by artificial intelligence. In some embodiments, the liveness engine may be configured to test whether a real person may be communicating with the automatic system.

In some embodiments, the liveness test engine may be configured to tell a real person from an AI-generated person via a liveness test. In some embodiments, the liveness test may be configured to utilize facial features, image and video analysis, facial expressions and micro movement analysis, voice verification, and behavior. Embodiments may also include analysis to tell a real person from an AI-generated person.

In some embodiments, the liveness test may be configured to utilize questioning and answering, or gesture judgment or body language response to tell a real person from any AI-generated person. In some embodiments, the liveness test engine may be configured to ask a person before a screen communicating with the liveness test engine to perform certain gestures, body poses or facial expressions, and via video recognition to determine whether the performances of the person before the screen exceeds a pre-determined threshold.

In some embodiments, when the performances exceed the pre-determined threshold, the person before the screen will be deemed a real person. Embodiments may also include a biometric data analysis system including a data input interface to obtain, for a user who already passes the liveness test to generate the visual person to execute the legal event, biometric data of the user to identify the user according to information of the user using any one or combination of a DNA analyzer to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system including a static image photographic system, and a dynamic video image photographic system, to record physical images of the user.

Embodiments may also include an AI system to generate a visual person via machine learning models trained on and associated with the biometric data of the user. Embodiments may also include a user interface to interact with the visual person. Embodiments may also include a legal document generator including at least one processor configured to obtain global positioning system (GPS) coordinates corresponding to a location of the legal event would occur.

In some embodiments, the legal document generator may include a time stamp retriever that may be configured to connect to an official time provider via a network and to retrieve an official current time corresponding to the notarization event. In some embodiments, the legal document generator may be configured to activate the visual person to execute the legal event. In some embodiments, the document of the legal event may be recorded with the biometric data of the user and the location and time of the legal event may be recorded with the document via the legal document generator and the time stamp retriever.

Embodiments of the present disclosure may also include an automated system to generate for a user, a visual person who may be able to execute a legal event for a target object, the system may include an enrollment system, including a liveness test engine driven by artificial intelligence. In some embodiments, the liveness engine may be configured to test whether a real person may be communicating with the automatic system.

In some embodiments, the liveness test engine may be configured to tell a real person from an AI-generated person via a liveness test. In some embodiments, the liveness test may be configured to utilize facial features, image and video analysis, facial expressions and micro movement analysis, voice verification, and behavior. Embodiments may also include analysis to tell a real person from an AI-generated person.

In some embodiments, the liveness test may be configured to utilize questioning and answering, or gesture judgment or body language response to tell a real person from any AI-generated person. In some embodiments, the liveness test engine may be configured to ask a person before a screen communicating with the liveness test engine to perform certain gestures, body poses or facial expressions, and via video recognition to determine whether performances of the person before the screen exceeds a pre-determined threshold.

In some embodiments, when the performances exceed the pre-determined threshold, the person before the screen will be deemed a real person. Embodiments may also include a biometric data analysis system including a data input interface to obtain, for a user who already passes the liveness test to generate the visual person to execute the legal event, biometric data of the user to identify the user according to information of the user using any one or combination of a DNA analyzer to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system including a static image photographic system, and a dynamic video image photographic system, to record physical images of the user.

Embodiments may also include an AI system to generate a visual person via machine learning models trained on and associated with the biometric data of the user. Embodiments may also include a user interface to interact with the visual person. Embodiments may also include a legal document generator including at least one processor configured to obtain global positioning system (GPS) coordinates corresponding to a location of the legal event would occur.

In some embodiments, the legal document generator may include a time stamp retriever that may be configured to connect to an official time provider via a network and to retrieve an official current time corresponding to the notarization event. In some embodiments, the legal document generator may be configured to activate the visual person to execute the legal event.

In some embodiments, the document of the legal event may be recorded with biometric data of the user and the location and time of the legal event may be recorded. Embodiments may also include a marking system to mark the legal document with the official legal mark. Embodiments may also include a data storage to store a legal file associated with the legal mark. In some embodiments, the legal file may be configured to sent to an official government depository.

Embodiments of the present disclosure may also include an automated system for executing a legal event, the system may include an enrollment system, including a liveness test engine driven by artificial intelligence. In some embodiments, the liveness engine may be configured to test whether a real person may be communicating with the automatic system.

In some embodiments, the liveness test engine may be configured to tell a real person from an AI-generated person via a liveness test. In some embodiments, the liveness test may be configured to utilize facial features, image and video analysis, facial expressions and micro movement analysis, voice verification, and behavior. Embodiments may also include analysis to tell a real person from an AI-generated person.

In some embodiments, the liveness test may be configured to utilize questioning and answering, gesture judgment and body language response to tell a real person from any AI-generated person. In some embodiments, the liveness test engine may be configured to ask a person before a screen communicating with the liveness test engine to perform certain gestures, body poses and facial expressions, and via video recognition to determine whether performances of the person before the screen exceeds a pre-determined threshold.

In some embodiments, when the performances exceed the pre-determined threshold, the person before the screen will be deemed a real person. Embodiments may also include a biometric data analysis system including a data input interface to obtain, for a user who already passes the liveness test to generate the visual person to execute the legal event, biometric data of the user to identify the user according to information of the user using any one or combination of a DNA analyzer to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system including a static image photographic system, and a dynamic video image photographic system, to record physical images of the user.

Embodiments may also include an AI system to generate a visual person via machine learning models trained on and associated with the biometric data of the user. Embodiments may also include a user interface to interact with the visual person. Embodiments may also include a legal document generator including at least one processor configured to obtain global positioning system (GPS) coordinates corresponding to a location of the legal event would occur.

In some embodiments, the legal document generator may include a time stamp retriever that may be configured to connect to an official time provider via a network and to retrieve an official current time corresponding to the notarization event. In some embodiments, the legal document generator may be configured to activate the visual person to execute the legal event. In some embodiments, the document of the legal event may be recorded with biometric data of the user and the location and time of the legal event may be recorded with the document via the legal document generator and the time stamp retriever.

### BRIEF DESCRIPTION OF THE FIGURES

FIG. 1 is a block diagram illustrating an automated system, according to some embodiments of the present disclosure.

FIG. 2 is a block diagram illustrating an automated system, according to some embodiments of the present disclosure.

FIG. 3 is a block diagram illustrating an automated system, according to some embodiments of the present disclosure.

FIG. 4 is a diagram showing an example of an automated system, according to some embodiments of the present disclosure.

FIG. 5 is a diagram showing a second example of an automated system, according to some embodiments of the present disclosure.

FIG. 6 is a diagram showing a third example of an automated system, according to some embodiments of the present disclosure.

FIG. 7 is a diagram showing a fourth example of an automated system, according to some embodiments of the present disclosure.

FIG. 8 is a diagram showing a fifth example of an automated system, according to some embodiments of the present disclosure.

### DETAILED DESCRIPTION

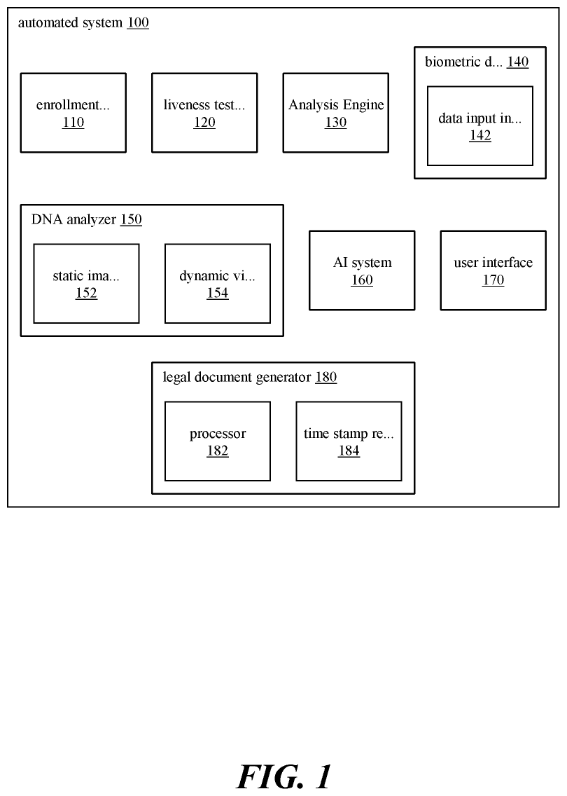

FIG. 1 is a block diagram that describes an automated system 100, according to some embodiments of the present disclosure. In some embodiments, the automated system 100 may include an enrollment system 110, a liveness test engine 120 driven by artificial intelligence, analysis engine 130 to tell a real person from an AI-generated person, a biometric data analysis system 140, an AI system 160 to generate a visual person via machine learning models trained on and associated with the biometric data of the user, a user interface 170 to interact with the visual person, and a legal document generator 180.

In some embodiments, the automated system 100 may also include a DNA analyzer 150 to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system.

In some embodiments, the liveness engine may be configured to test whether a real person may be communicating with the automatic system. The liveness test engine 120 may be configured to tell a real person from an AI-generated person via a liveness test. The liveness test may be configured to utilize facial features, image and video analysis, facial expressions and micro movement analysis, voice verification, and behavior.

In some embodiments, the liveness test may be configured to utilize questioning and answering, or gesture judgment or body language response to tell a real person from any AI-generated person. The liveness test engine 120 may be configured to ask a person before a screen communicating with the liveness test engine 120 to perform certain gestures, body poses or facial expressions, and via video recognition to determine whether performances of the person before the screen exceeds a pre-determined threshold.

In some embodiments, when the performances may exceed the pre-determined threshold, the person before the screen will be deemed a real person. The biometric data analysis system 140 may also include a data input interface 142 to obtain, for a user who already passes the liveness test to generate the visual person to execute the legal event, biometric data of the user to identify the user according to information of the user using any one or combination of.

In some embodiments, the DNA analyzer 150 may include a static image photographic system 152. The DNA analyzer 150 may also include a dynamic video image photographic system 154, to record physical images of the user. The legal document generator 180 may include at least one processor 182 configured to obtain global positioning system (GPS) coordinates corresponding to a location of the legal event would occur and a time stamp retriever 184 that may be configured to connect to an official time provider via a network and to retrieve an official current time corresponding to the notarization event. The legal document generator 180 may be configured to activate the visual person to execute the legal event. The document of the legal event may be recorded with biometric data of the user and the location and time of the legal event may be recorded with the document via the legal document generator 180 and the time stamp retriever 184.

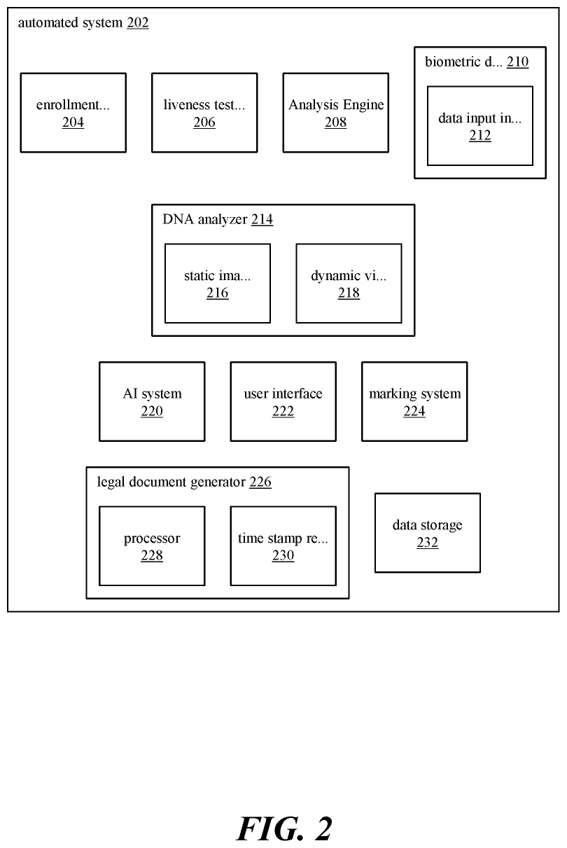

FIG. 2 is a block diagram that describes an automated system 202, according to some embodiments of the present disclosure. In some embodiments, the automated system 202 may include an enrollment system 204, a liveness test engine 206 driven by artificial intelligence, analysis engine 208 to tell a real person from an AI-generated person, a biometric data analysis system 210, an AI system 220 to generate a visual person via machine learning models trained on and associated with the biometric data of the user, a user interface 222 to interact with the visual person, a legal document generator 226, a marking system 224 to mark the legal document with the official legal mark, and a data storage 232 to store a legal file associated with the legal mark.

In some embodiments, the automated system 202 may also include a DNA analyzer 214 to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system.

In some embodiments, the liveness engine may be configured to test whether a real person may be communicating with the automatic system. The liveness test engine 206 may be configured to tell a real person from an AI-generated person via a liveness test. The liveness test may be configured to utilize facial features, image and video analysis, facial expressions and micro movement analysis, voice verification, and behavior.

In some embodiments, the liveness test may be configured to utilize questioning and answering, or gesture judgment or body language response to tell a real person from any AI-generated person. The liveness test engine 206 may be configured to ask a person before a screen communicating with the liveness test engine 206 to perform certain gestures, body poses or facial expressions, and via video recognition to determine whether performances of the person before the screen exceeds a pre-determined threshold.

In some embodiments, when the performances may exceed the pre-determined threshold, the person before the screen will be deemed a real person. The biometric data analysis system 210 may also include a data input interface 212 to obtain, for a user who already passes the liveness test to generate the visual person to execute the legal event, biometric data of the user to identify the user according to information of the user using any one or combination of.

In some embodiments, the DNA analyzer 214 may include a static image photographic system 216. The DNA analyzer 214 may also include a dynamic video image photographic system 218, to record physical images of the user. The legal document generator 226 may include at least one processor 228 configured to obtain global positioning system (GPS) coordinates corresponding to a location of the legal event would occur and a time stamp retriever 230 that may be configured to connect to an official time provider via a network and to retrieve an official current time corresponding to the notarization event. The legal document generator 226 may be configured to activate the visual person to execute the legal event. The document of the legal event may be recorded with biometric data of the user and the location and time of the legal event may be recorded. The legal file may be configured to sent to an official government depository.

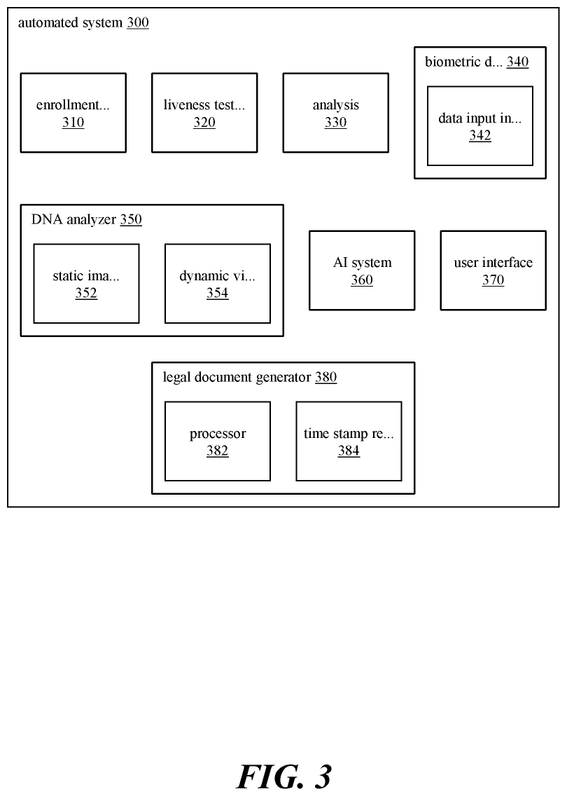

FIG. 3 is a block diagram that describes an automated system 300, according to some embodiments of the present disclosure. In some embodiments, the automated system 300 may include an enrollment system 310, a liveness test engine 320 driven by artificial intelligence, analysis 330 to tell a real person from an AI-generated person, a biometric data analysis system 340, an AI system 360 to generate a visual person via machine learning models trained on and associated with the biometric data of the user, a user interface 370 to interact with the visual person, and a legal document generator 380.

In some embodiments, the automated system 300 may also include a DNA analyzer 350 to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system.

In some embodiments, the liveness engine may be configured to test whether a real person may be communicating with the automatic system. The liveness test engine 320 may be configured to tell a real person from an AI-generated person via a liveness test. The liveness test may be configured to utilize facial features, image and video analysis, facial expressions and micro movement analysis, voice verification, and behavior.

In some embodiments, the liveness test may be configured to utilize questioning and answering, gesture judgment and body language response to tell a real person from any AI-generated person. The liveness test engine 320 may be configured to ask a person before a screen communicating with the liveness test engine 320 to perform certain gestures, body poses and facial expressions, and via video recognition to determine whether performances of the person before the screen exceeds a pre-determined threshold.

In some embodiments, when the performances may exceed the pre-determined threshold, the person before the screen will be deemed a real person. The biometric data analysis system 340 may also include a data input interface 342 to obtain, for a user who already passes the liveness test to generate the visual person to execute the legal event, biometric data of the user to identify the user according to information of the user using any one or combination of.

In some embodiments, the DNA analyzer 350 may include a static image photographic system 352. The DNA analyzer 350 may also include a dynamic video image photographic system 354, to record physical images of the user. The legal document generator 380 may include at least one processor 382 configured to obtain global positioning system (GPS) coordinates corresponding to a location of the legal event would occur and a time stamp retriever 384 that may be configured to connect to an official time provider via a network and to retrieve an official current time corresponding to the notarization event. The legal document generator 380 may be configured to activate the visual person to execute the legal event. The document of the legal event may be recorded with biometric data of the user and the location and time of the legal event may be recorded with the document via the legal document generator 380 and the time stamp retriever 384.

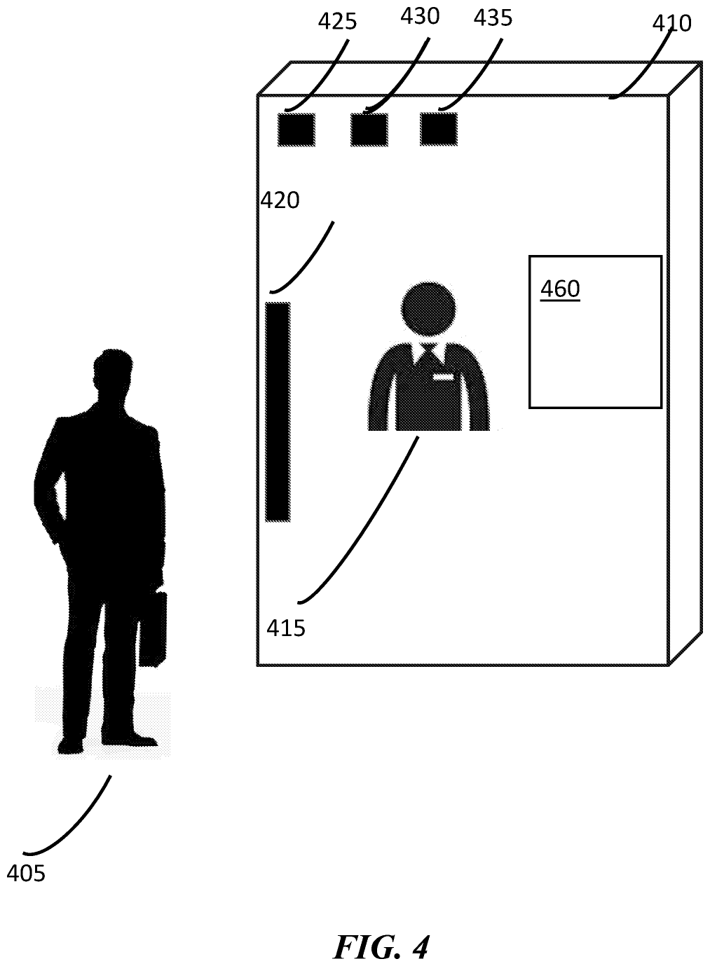

FIG. 4 is a diagram showing an example that describes an automated system, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the legal process with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to be used.

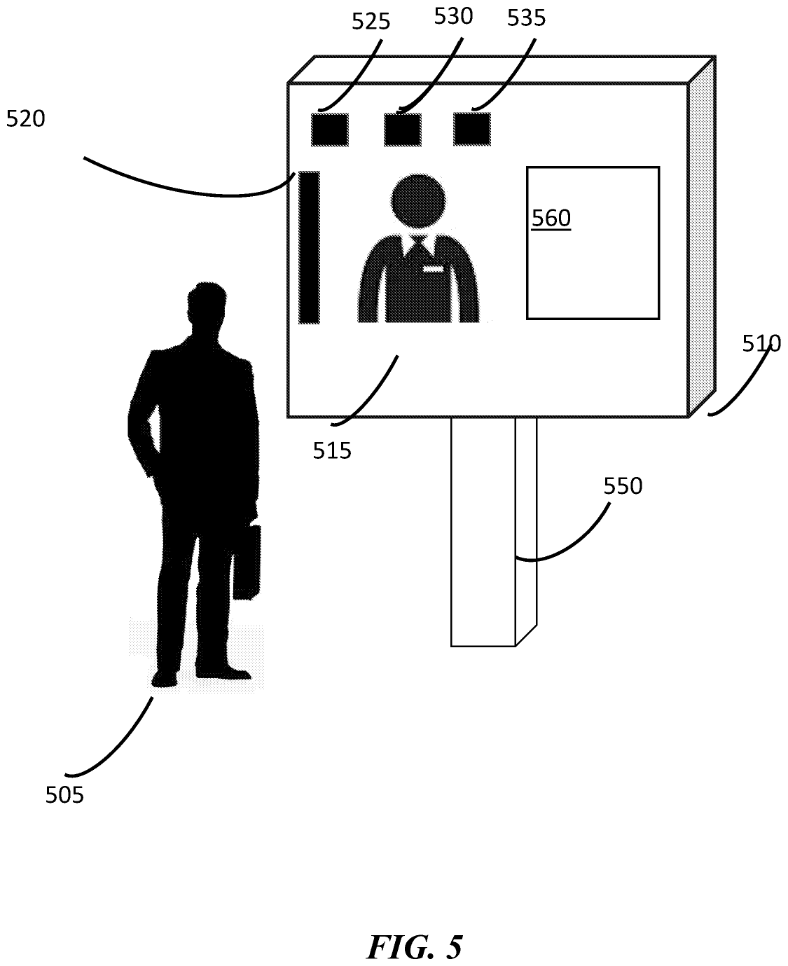

FIG. 5 is a diagram showing an example that describes an automated system, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the legal process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used.

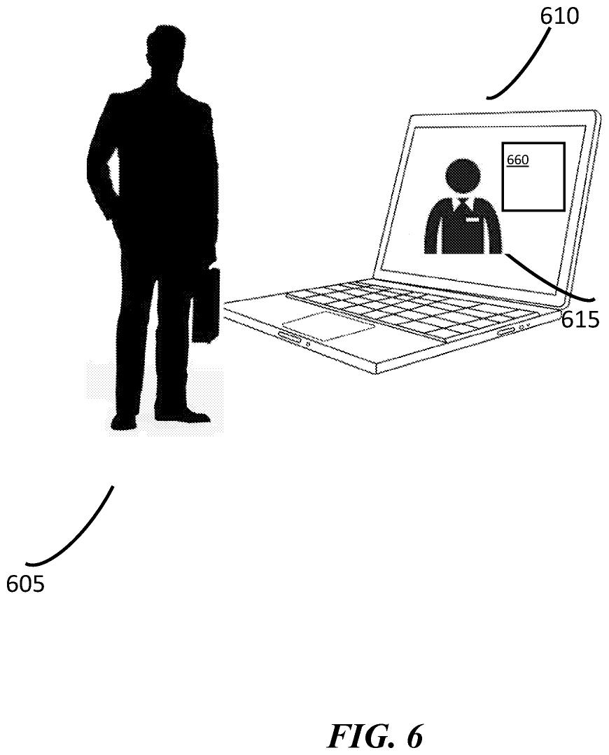

FIG. 6 is a diagram showing an example that describes an automated system, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the legal process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use.

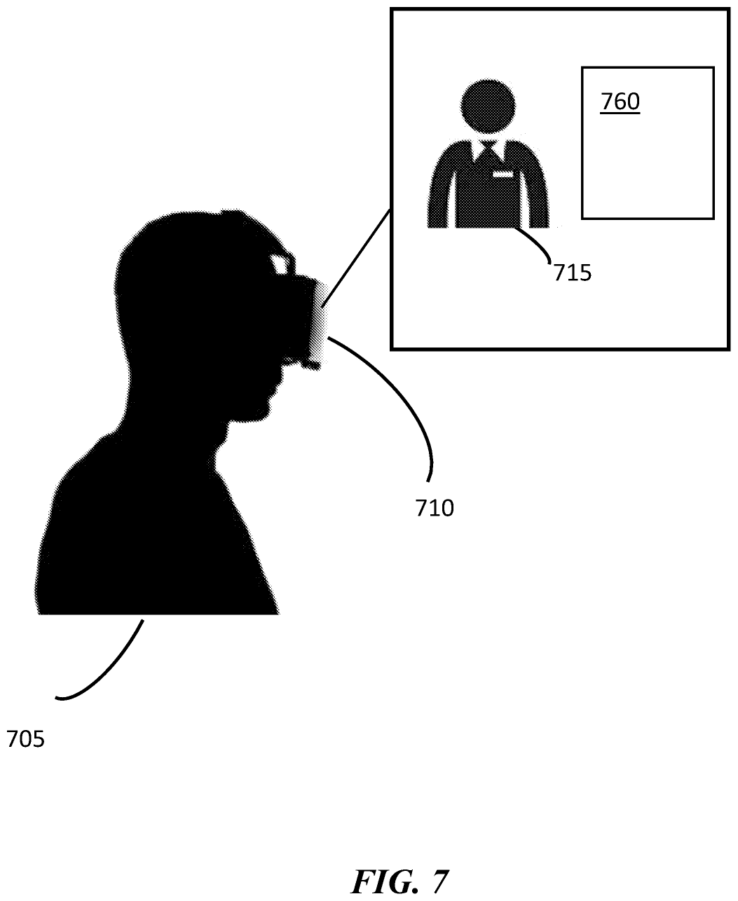

FIG. 7 is a diagram showing an example that describes an automated system, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the legal process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use.

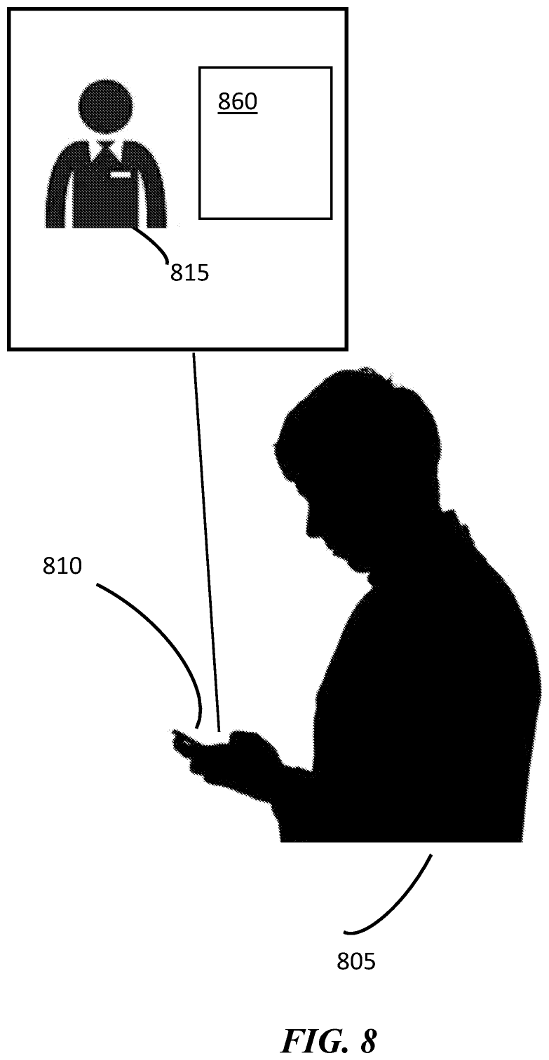

FIG. 8 is a diagram showing an example that describes an automated system, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the legal process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used.

1. An automated system for executing a legal event, the system comprises:
an enrollment system, comprising:
a liveness test engine driven by artificial intelligence, wherein the liveness engine is configured to test whether a real person is communicating with the automatic system, wherein the liveness test engine is configured to tell a real person from an AI-generated person via a liveness test, wherein the liveness test is configured to utilize facial features, image and video analysis, facial expressions and micro movement analysis, voice verification, and behavior analysis to tell a real person from an AI-generated person, wherein the liveness test is configured to utilize questioning and answering, or gesture judgment or body language response to tell a real person from any AI-generated person, wherein the liveness test engine is configured to ask a person before a screen communicating with the liveness test engine to perform certain gestures, body poses or facial expressions, and via video recognition to determine whether performances of the person before the screen exceeds a pre-determined threshold, wherein when the performances exceed the pre-determined threshold, the person before the screen will be deemed a real person;
a biometric data analysis system including a data input interface to obtain, for a user who already passes the liveness test to generate the visual person to execute the legal event, biometric data of the user to identify the user according to information of the user using any one or combination of:
a DNA analyzer to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system including a static image photographic system, and a dynamic video image photographic system, to record physical images of the user;
an AI system to generate a visual person via machine learning models trained on and associated with the biometric data of the user;
a user interface to interact with the visual person; and
a legal document generator including at least one processor configured to obtain global positioning system (GPS) coordinates corresponding to a location of the legal event would occur, wherein the legal document generator comprises a time stamp retriever that is configured to connect to an official time provider via a network and to retrieve an official current time corresponding to the notarization event, wherein the legal document generator is configured to activate the visual person to execute the legal event, wherein the document of the legal event is recorded with biometric data of the user and the location and time of the legal event is recorded with the document via the legal document generator and the time stamp retriever.

2. An automated system to generate for a user, a visual person who is able to execute a legal
event for a target object, the system comprises:
an enrollment system, comprising:
a liveness test engine driven by artificial intelligence, wherein the liveness engine is configured to test whether a real person is communicating with the automatic system, wherein the liveness test engine is configured to tell a real person from an AI-generated person via a liveness test, wherein the liveness test is configured to utilize facial features, image and video analysis, facial expressions and micro movement analysis, voice verification, and behavior analysis to tell a real person from an AI-generated person, wherein the liveness test is configured to utilize questioning and answering, or gesture judgment or body language response to tell a real person from any AI-generated person, wherein the liveness test engine is configured to ask a person before a screen communicating with the liveness test engine to perform certain gestures, body poses or facial expressions, and via video recognition to determine whether performances of the person before the screen exceeds a pre-determined threshold, wherein when the performances exceed the pre-determined threshold, the person before the screen will be deemed a real person;
a biometric data analysis system including a data input interface to obtain, for a user who already passes the liveness test to generate the visual person to execute the legal event, biometric data of the user to identify the user according to information of the user using any one or combination of:
a DNA analyzer to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system including a static image photographic system, and a dynamic video image photographic system, to record physical images of the user;
an AI system to generate a visual person via machine learning models trained on and associated with the biometric data of the user;
a user interface to interact with the visual person;
a legal document generator including at least one processor configured to obtain global positioning system (GPS) coordinates corresponding to a location of the legal event would occur, wherein the legal document generator comprises a time stamp retriever that is configured to connect to an official time provider via a network and to retrieve an official current time corresponding to the notarization event, wherein the legal document generator is configured to activate the visual person to execute the legal event, wherein the document of the legal event is recorded with biometric data of the user and the location and time of the legal event is recorded;
a marking system to mark the legal document with the official legal mark; and
data storage to store a legal file associated with the legal mark, wherein the legal file is configured to sent to an official government depository.

3. An automated system for executing a legal event, the system comprises:
an enrollment system, comprising:
a liveness test engine driven by artificial intelligence, wherein the liveness engine is configured to test whether a real person is communicating with the automatic system, wherein the liveness test engine is configured to tell a real person from an AI-generated person via a liveness test, wherein the liveness test is configured to utilize facial features, image and video analysis, facial expressions and micro movement analysis, voice verification, and behavior analysis to tell a real person from an AI-generated person, wherein the liveness test is configured to utilize questioning and answering, gesture judgment and body language response to tell a real person from any AI-generated person, wherein the liveness test engine is configured to ask a person before a screen communicating with the liveness test engine to perform certain gestures, body poses and facial expressions, and via video recognition to determine whether performances of the person before the screen exceeds a pre-determined threshold, wherein when the performances exceed the pre-determined threshold, the person before the screen will be deemed a real person;
a biometric data analysis system including a data input interface to obtain, for a user who already passes the liveness test to generate the visual person to execute the legal event, biometric data of the user to identify the user according to information of the user using any one or combination of:
a DNA analyzer to determine unique blood patterns, a hand geometry analyzer to determine unique hand patterns, a fingerprint scanner to determine unique fingerprint patterns, a signature analyzer to determine unique signature patterns, a facial recognizer to capture unique facial characteristics, a voice analyzer to determine unique vocal patterns, and an electro-optical photographic system including a static image photographic system, and a dynamic video image photographic system, to record physical images of the user;
an AI system to generate a visual person via machine learning models trained on and associated with the biometric data of the user;
a user interface to interact with the visual person; and
a legal document generator including at least one processor configured to obtain global positioning system (GPS) coordinates corresponding to a location of the legal event would occur, wherein the legal document generator comprises a time stamp retriever that is configured to connect to an official time provider via a network and to retrieve an official current time corresponding to the notarization event, wherein the legal document generator is configured to activate the visual person to execute the legal event, wherein the document of the legal event is recorded with biometric data of the user and the location and time of the legal event is recorded with the document via the legal document generator and the time stamp retriever.
